(19) United States
(12) Patent Application Publication
(10) Pub. No.: US 2005/0070442 A1
(43) Pub. Date: Mar. 31, 2005

(54) Mercury-based oxide superconductor composition

(76) Inventor: Matthew J. Holcomb, Metamora, MI (US)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 10/884,237

(22) Filed: Jul. 2, 2004

Related U.S. Application Data
(60) Provisional application No. 60/485,045, filed on Jul. 2, 2003.

(51) Int. Cl. H01B 1/00

(52) U.S. Cl. 505/100

(57) ABSTRACT

A method of making an oxide superconductor wire is described. A combination of YBa₂Cu₃O₇₋ₓ particles and HgO is prepared. The combination is formed into a wire. The combination is heated so that the HgO decomposes into Hg and O. The O from the HgO is provided to the particles. The Hg from the HgO is provided to the particles. The Hg from the HgO is noble with respect to the particles. The combination is allowed to cool at a rate sufficient to prevent recombination of the Hg and O from the HgO, so that at least a substantial portion of the Hg from the HgO remains in the metallic state.

### CROSS-REFERENCE TO RELATED APPLICATIONS

Priority is claimed from U.S. Provisional Patent Application No. 60/485,045, filed on Jul. 2, 2003.

### BACKGROUND OF THE INVENTION

1). Field of the Invention

This invention relates generally to the manufacture of an oxide superconductor composition, and more specifically to the manufacture of a low-cost, YBa₂Cu₃O7₋ₓ-based superconducting wire.

2). Discussion of Related Art

Today there are several approaches being pursued to fabricate commercial superconducting wire. These range from incremental improvements in the current carrying properties of technical Nb₃Sn conductors, to innovative manufacturing methods to fabricate long lengths of high-current coated conductors using the high temperature copper-oxide superconductors. Each approach brings some benefits and some challenges.

Superconducting magnets capable of generating magnetic fields in excess of 12 Tesla (T) at 4.2 Kelvin (K) for use in plasma fusion confinement systems, high energy physics accelerator applications, and high field nuclear magnetic resonance (NMR) are typically made using commercial multi-filamentary composite Nb₃Sn superconducting wire. Nb₃Sn is a brittle intermetallic superconductor. Thus, multi-filamentary wire is commonly made using a variety of wind-and-react methods in which Nb₃Sn filaments are formed in situ within a copper matrix through heat treatments after the wire is drawn to its final dimension. With an upper critical magnetic field (H_{c2}) of approximately 25 T at 4.2K, state-of-the-art Nb₃Sn wires can possess critical current densities (J_{C}) in excess of 10,000 A/cm² at 4.2K in a 20 T applied magnetic field.

In principle, superconducting materials such as Nb₃Al PbMo₆S₈, and the high-temperature superconducting (HTS) oxides with H_{c2} values higher than that of Nb₃Sn at 4.2K can be used to generate very high magnetic fields if high critical current density wires can be fabricated using these materials. In particular, partial-melt processed, relatively expensive silver-clad multi-filamentary HTS tapes made using Bi₂Sr₂CaCu₂O₈ or (BiPb)₂Sr₂Ca₂Cu₃O₈, with an H_{c2} in excess of 100 T at 4.2K, have been shown to possess sufficient critical current densities for use as insert coils in high field magnets. These hybrid superconducting magnets consist of both a low-temperature superconductor (LTS) and an HTS coil. In general, these magnets use multi-filamentary composite Nb₃Sn wire in the outer coil to generate the base magnetic field and a multi-filamentary silver-clad HTS tape in the insert coil to raise the magnetic field an additional 3 to 5 T at 4.2K. The general focus in the further development of such silver-clad multi-filamentary HTS tapes is to improve the performance and reduce the cost of the HTS tape.

Commercial and academic development efforts on HTS conductors have evolved into two distinct conductor geometries: Powder-in-Tube (PIT) tape and Coated Conductor (CC) ribbons. The only commercially available HTS tape is fabricated by the PIT method using either Bi₂Sr₂CaCu₂O₈ (BSCCO-2212) or (BiPb)₂Sr₂Ca₂Cu₃O₈ (BSCCO-2223). To construct these tapes, precursor powders of the relevant metal oxides are placed in a silver tube. Then, through a series of wire drawing, rolling and annealing procedures, a superconducting tape is formed. The specific conductor forming and annealing processes affect the texturing, or orientation, of the HTS crystallites within the silver sheath. Supercurrent transport in the BSCCO materials is known to be highly anisotropic, so that the current carrying capacity of these tapes increases as more crystallites align within the central filament. The micaceous BSCCO materials are particularly susceptible to grain self-alignment during the deformation procedures, and HTS PIT tapes are all made using these materials. The final geometry of mono-filament BSCCO PIT tape is that of a granular ceramic BSCCO core with a thick, relatively expensive silver sheath.

State-of-the-art HTS PIT tape contains over 80 thin BSCCO filaments embedded in a high purity, silver or silver alloy sheath. The current carrying capacity of these tapes is known to be limited by the numerous weak-link contacts that form at the grain boundaries within the filaments. The current flow is severely attenuated by these weak-links because HTS materials have very short coherence lengths, on the order of the width of the grain boundary itself. Thus, the weak-link inter-grain contact is a significant barrier through which the supercurrent must tunnel. This is not the case for many LTS materials where the width of the grain boundary is negligible with respect to the superconducting coherence length of the material. In addition, small inter-grain contact areas within the filament dramatically reduce the current carrying cross-sectional area, and thus the total current carrying capacity of the tape. Magneto-optical imaging of BSCCO PIT tape indicates that the supercurrent flow in the filament is percolative and flows primarily near the BSCCO/silver interface, where grain alignment is the highest, with very little current flowing through the filament core.

Many technological hurdles have been overcome in the development of high-current BSCCO PIT tape, and today, long lengths of these conductors are produced commercially with engineering critical current densities (J_{E}) in excess of 10,000 A/cm² at 77K in self-field. Unfortunately, the poor intrinsic magnetic flux pinning properties of the BSCCO materials prevents these composite tapes from being used in magnetic field applications at temperatures above approximately 30K. At 4.2K, however, the magnetic flux which penetrates the BSCCO material is effectively pinned and partial-melt processed BSCCO-2212 tape can possess a large enough critical current density to be used in the insert coil for hybrid high field magnets.

The poor magnetic flux pinning properties at elevated temperatures and the weak-link limited critical current densities of BSCCO PIT tapes have stimulated an increased research and development effort in the fabrication of HTS Coated Conductor ribbons. These “second generation” HTS conductors are fabricated on a textured nickel-alloy substrate ribbon. An insulating, highly oriented buffer layer is first deposited on the nickel-alloy ribbon and then a thin film of YBa₂Cu₃O₇₋ₓ (YBCO) is deposited upon this buffer layer. Finally, a protective coating of relatively expensive silver is deposited on the surface of the HTS layer. The superconducting YBCO layer must be a highly oriented thin film to be capable of supporting large supercurrents. Misorientation angles in YBa₂Cu₃O₇₋ₓ [001]-tilt grain boundaries as low as 20 degrees are known to reduce the inter-grain critical current density in excess of two orders of magnitude. By minimizing the number of low angle tilt grain boundaries in the thin YBCO layer, critical currents in excess of 1,000,000 A/cm² have been obtained in CC ribbons at 77K in self-field.

Unlike BSCCO, the intrinsic magnetic flux pinning properties of YBCO are very strong at temperatures as high at 77K, thus high current density conductors made from this material will have many uses in high magnetic field applications. Unfortunately, because the YBCO grains are not as susceptible to texturing as the micaceous BSCCO grains, no high current PIT wire or tape has been made using YBa₂Cu₃O₇₋ₓ. To date, YBCO CC technology remains the only method to fabricate high critical current density YBCO-based conductors, albeit in short lengths.

Manufacturing kilometer lengths of high-current YBCO CC ribbon promises to be challenging and capital intensive. Development has been ongoing for several years and companies focused on the commercialization of YBCO CC ribbon expect these conductors to replace BSCCO PIT tape within 3 to 5 years if the process can be shown to be scalable. Recently, American Superconductor has announced the development of an 8 m length of CC ribbon with a critical current density in excess of 100 A per cm ribbon width at 77K in self-field. This is an impressive achievement in the engineering of these composite conductors. However, high field insert magnets for use in plasma fusion confinement systems, and high field magnets, will require unbroken kilometer lengths of mechanically robust conductor for stable operation. Thus, the primary challenge in the commercialization of this technology lies in the fabrication of kilometer length, mechanically robust, high current CC ribbon.

The application space available to HTS-based devices depends critically on the continuing advancement of innovative manufacturing processes that produce high current density conductors at reduced cost relative to those available today. The two leading HTS conductor technologies have concentrated development on either improving the current carrying properties of an easily fabricated conductor (BSCCO PIT tape) or on improving the manufacturing processes to construct long lengths of high current density conductor (YBCO CC ribbon). Recently, Dr. Paul Grant of the Electric Power Research Institute presented competitive costs ($/kA·m) of a number of different superconducting conductor technologies. Although these costs have been calculated based on low magnetic field applications, the table is instructive in that it highlights the cost drivers for the competing superconducting technologies. The major cost driver for both Nb₃Sn wire and BSCCO PIT tape is the material used to construct the conductor, Nb and Ag, respectively, while the dominant cost driver for YBCO CC ribbon is associated with the capital equipment required to manufacture the conductor. From this, it may be estimated that at least 75% of the cost of BSCCO tape is associated with the materials cost of the high purity, relatively expensive silver or silver-alloy sheath, which comprises nearly 70% of the total volume of the tape.

Competitive Costs of Superconducting Conductor Technologies

| Wire | $/kA · m | Cost Driver |
|---|---|---|
| NbTi (4.2K, 2 T) | 0.90 | Materials (Nb) |
| Nb₃Sn (4.2K, 10 T) | 10 | Materials (Nb) |
| BSCCO-2223 (25K, 1 T) | 25 | Materials (Ag) |
| YBCO-CC (25K, 1 T) | 4 | Capital Plant |

Metallic silver is both highly permeable to oxygen at high temperature and noble with respect to detrimental reactions with HTS materials. Thus, it is critical in the manufacture of BSCCO PIT wire. Silver and silver alloys are unique in this respect. If the silver alloy sheath alone could be eliminated from an HTS PIT tape, it would result in a dramatic reduction in the cost of the conductor.

### SUMMARY OF THE INVENTION

The invention provides a method of making an oxide superconductor composition. A combination of oxide superconductor particles and a mercury-containing oxide material is prepared. The composition is heated and subsequently cooled. The composition may be allowed to cool to room temperature, cooled in a controlled manner to a temperature, or quenched rapidly to a temperature.

The combination may be a mixture that is loaded into a billet. The billet may then be closed and the closed billet containing the combination can be formed into a wire.

The particles may be annealed after forming the billet containing the composition into the wire.

The billet may be made of stainless steel, Mo, Nb, or Ta.

The billet containing the mixture may be inserted into a copper sleeve. The sleeve containing the billet can be further formed into a wire.

The mercury-containing oxide material may decompose into at least Hg and O, the O being provided to the particles.

The O may oxygenate the particles.

The Hg may surface-dope the particles.

The invention also provides a method of making an oxide superconductor wire, including preparing a combination of YBa₂Cu₃O₇₋ₓ HTS particles and HgO, drawing the combination into an elongate form, heating the combination so that the HgO decomposes into at least Hg and O, the O from the HgO being provided to the particles and the Hg from the HgO being noble with respect to the particles, and cooling the combination in a manner sufficient to prevent recombination of prevent recombination of the Hg and O from the HgO so that at least a substantial portion of the Hg remains in a metal state.

### BRIEF DESCRIPTION OF THE DRAWINGS

The invention is further described by way of examples with reference to the accompanying drawings, wherein:

FIG. 1 is a perspective view of a stainless steel billet that is loaded with a mercury-containing oxide superconductor composition according to an embodiment of the invention;

FIG. 2 is a view similar to FIG. 1, illustrating one manner of sealing the billet;

FIG. 3 is a chart illustrating how the mixture is heated and cooled;

FIG. 4 is a portion of the periodic table of elements, illustrating how the materials that are noble with respect to copper oxide are placed on the table, together with their ΔH_{f}, Tc and λ* values; and

FIGS. 5 to 11 illustrate the manufacture of a wire having a stainless steel and copper jacket.

### DETAILED DESCRIPTION OF THE INVENTION

Described hereinbelow is the construction of a low cost, wind-and-react PIT superconducting wire using YBa₂Cu₃O₇₋ₓ superconductor powder and a novel in situ oxygenation/grain boundary doping procedure facilitated through the decomposition of mercuric oxide, HgO. The HTS PIT wires and tapes fabricated using this approach have a high potential for improved conductor performance and low fabrication costs relative to competing HTS conductor technologies. Further, these conductors may find application at 77K in low magnetic fields in addition to their use in plasma fusion confinement systems, high field magnets, and high field NMR at 4.2K.

Fabrication Method Utilizing HgO

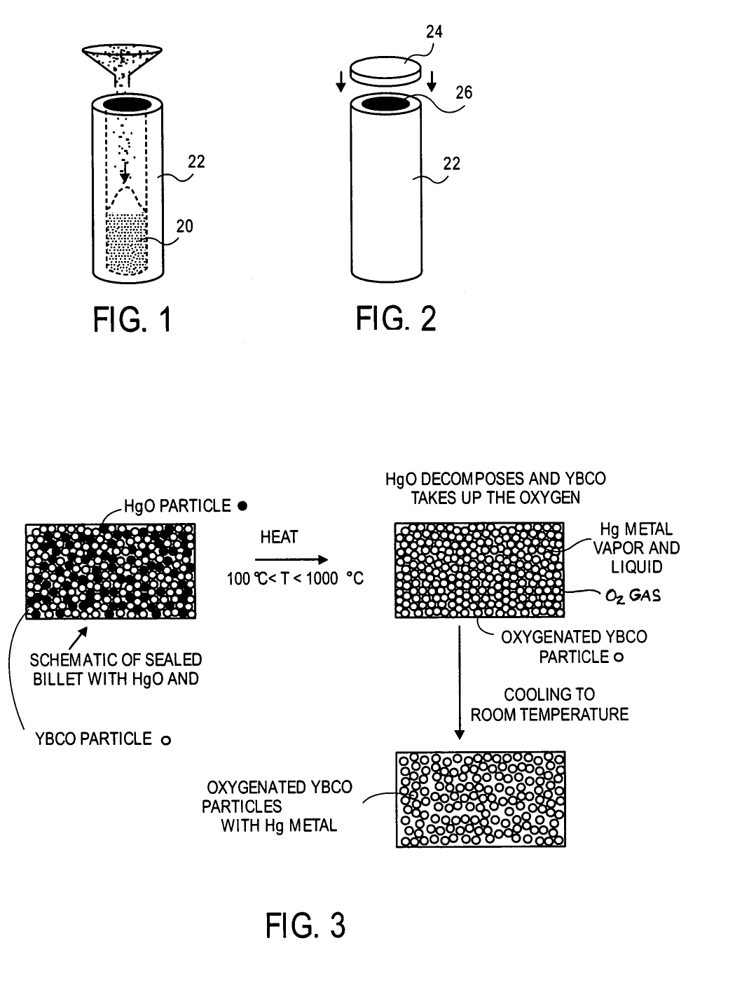

First, high-quality YBa₂Cu₃O₇₋ₓ powder with x between 0 and 1, preferably between 0 and 0.5, and HgO powder are ball milled under mild conditions in an inert atmosphere to produce a homogeneous mixture of the two powders. As illustrated in FIG. 1, the powder mixture 20 is then packed into a stainless steel billet 22. As illustrated in FIG. 2, a cap 24 is placed over a mouth 26 of the billet 22 and welded shut. Alternatively, the ends of the billet 22 may be closed by a number of methods known to those skilled in the art, such as crimping, swaging, screw insertion, plug insertion, and soldering. The closing of the billet 22 containing the combination is meant to substantially contain the combination during the heating and cooling treatments. The welded billet 22 is then formed into an elongate member using standard drawing and rolling procedures. A final heat treatment of the elongate member will then produce the superconducting core filament. The heat treatment may be accomplished by a number of methods known to those skilled in the art, such as placing the elongate member in a furnace with controlled temperature and atmosphere capabilities, moving the elongate member through a heated zone of a furnace, or by passing sufficient current through a region of the sheath of the elongate member as to produce localized resistive heating of the elongate member. The heat treatment is performed in such a manner sufficient to result in the substantial decomposition of the mercury-containing oxide material. Unlike standard BSCCO PIT tape preparation methods in which the silver clad tape is annealed in an oxygen rich atmosphere, this method uses the thermal decomposition of HgO as an internal oxygen source.

The key benefits of to this approach are: (1) Fully oxygenating the YBCO in situ through the decomposition of HgO; and (2) Surface doping the YBCO with Hg during the same oxygenation reaction, leading to improved current carrying properties at the grain boundaries in the filament.

Fabrication Method Utilizing HgO and Ag₂O

First, high-quality YBa₂Cu₃O₇₋ₓ powder, HgO powder, and Ag₂O are ball milled under mild conditions in an inert atmosphere to produce a homogeneous mixture of the three powders. As illustrated in FIG. 1, the powder mixture 20 is then packed into a stainless steel billet 22. As illustrated in FIG. 2, a cap 24 is placed over a mouth 26 of the billet 22 and welded shut. Alternatively, the ends of the billet 22 may be closed by a number of methods known to those skilled in the art, such as crimping, swaging, screw insertion, plug insertion, and soldering. A final heat treatment of the closed wire will then produce the superconducting core filament. The addition of Ag₂O to the composition allows for the dilution of the Hg in the composition, providing a mercury silver containing alloy in the core filament, and has the beneficial effect of providing O to the oxide superconductor particles.

Fabrication Method Utilizing HgO and Hg

First, high-quality YBa₂Cu₃O₇₋ₓ powder, HgO powder, and liquid Hg are ball milled under mild conditions in an inert atmosphere to produce a homogeneous mixture of the two powders and liquid metal. As illustrated in FIG. 1, the powder mixture 20 is then packed into a stainless steel billet 22. As illustrated in FIG. 2, a cap 24 is placed over a mouth 26 of the billet 22 and welded shut. Alternatively, the ends of the billet 22 may be closed by a number of methods known to those skilled in the art, such as crimping, swaging, screw insertion, plug insertion, and soldering. A final heat treatment of the closed wire will then produce the superconducting core filament. The addition of Hg metal to the composition allows for the dilution of the available O in the composition and an increased mercury content in the core filament.

Controlling the materials chemistry within the central filament is critical to fabricating a high current superconducting wire in this approach. Mercuric oxide is a poisonous, light-sensitive, reddish-orange crystalline material that decomposes to metallic mercury (Hg) and oxygen (O₂) at temperatures greater than 500° C. YBCO is an air-sensitive, black powder which melts incongruently to (YBa₂Cu₃O₆₊ₓ+BaCuO₂+Liquid) at 890° C. The highest temperature superconducting phase of YBa₂Cu₃O₇₋ₓ is obtained only in optimally doped materials with x less than approximately 0.1. Unlike the BSCCO materials, none of which exist with ideal cation stoichiometry, YBCO is a cation stochiometric material with variable oxygen content from 6 to 7 in the unit cell. Non-superconducting YBa₂Cu₃O_{“6”} is a tetragonal, anti-ferromagnetic insulator.

To prepare the composition, the mixture is heated, typically within a sealed wire, to a temperature between 100° C. and 1000° C. The thermal decomposition of HgO into Hg and O₂ gas begins at approximately 550° C. under argon gas, and is complete by 650° C.

Fully oxygenated YBCO begins to lose oxygen at temperatures as low as 250° C. and continues to evolve O₂ gas at temperatures as high as 800° C. Presumably, the oxygen that is lost at low temperatures is the extremely labile “chain” oxygen near the surface of the particle. At elevated temperatures, the oxygen is migrating from the bulk of the material.

At temperatures above the decomposition temperature of HgO, the chemistry within the filament can be summarized as follows:
2 HgO→2 Hg_{(gas)}+O_{2(gas)} [1]
(surface layer) YBa₂Cu₃O_{“6”}+O_{2(gas)}→YBa₂Cu₃O_{“7”} [2]
(bulk) YBa₂Cu₃O_{“7”}+O_{2(gas)} [symbol] YBa₂Cu₃O_{“}7” [3]
(surface layer) YBa₂Cu₃O_{“7”}+Hg(gas)→Y_{1-y}Hg_{y} Ba₂Cu₃O_{“7”} [4]

These reactions are not intended to represent a balanced stoichiometric set of simultaneous reactions, but are a hypothesis as to what chemistry may occur within the sealed filament at these temperatures. Reaction [1] is the stoichiometric decomposition of mercuric oxide to mercury and oxygen which will run to completion at temperatures above 550° C. Reaction [2] represents the oxygenation of the oxygen-deficient surface of YBCO to the fully oxygenated state which will occur at high temperatures in the presence of O₂ gas. Recall that only optimally doped, fully oxygenated YBCO is a high temperature superconductor. Reaction [3] represents the equilibrium that exists between YBCO and O₂ as the bulk material exchanges oxygen with the O₂ rich environment at these high temperatures. Reaction [4] represents the doping of the YBCO surface with mercury, which may improve supercurrent conduction at the grain boundaries in the filament. The latter is predicted to occur based on a number of related doping studies in which Y has been replaced with Ca in the YBCO crystal structure.

The filament is then cooled. The filament may be allowed to cool to room temperature, be cooled in a controlled manner to a specific temperature, or quenched quickly to a specific temperature. The cooling methods utilized prevent the recombination of Hg and O to minimize the formation of HgO within the filament. Thus, upon cooling in a specific manner, the billet 22 containing the YBa₂Cu₃O₇₋ₓ/HgO combination should be composed of:
(bulk) YBa₂Cu₃O_{“7”},
(particle surface/grain boundary) Y_{1-z}Hg_{z} Ba₂Cu₃O_{“7”}, and
(interstitial regions) Y_{1-z}Hg_{z} Ba₂Cu₃O_{“7”}/Hg₍ₘₑₜₐₗ₎
where z may vary from 0 to 1, depending on the degree of local doping in the composition.

After heat treatment, the filament should consist primarily of bulk, superconducting YBCO, which, in addition to being fully oxygenated, has also been surface doped with Hg at the Y site in the grain boundaries.

Recently, there have been many measurements performed on low angle tilt grain boundaries in YBCO which demonstrate the beneficial effects of replacing Y with Ca at the grain boundary. This doping results in a dramatic increase in the critical current density of these low-angle tilt grain boundaries. As discussed previously, grain boundaries in HTS materials are known to be detrimental to the flow of supercurrent. The reasons for this are not completely understood, but are most likely intimately connected to the very short coherence lengths of these materials. Even in very clean grain boundaries, the critical current density decreases rapidly with increasing misorientation angle. This decrease has been attributed to a lack of local stoichiometry at the grain boundary, an increasing dislocation density with increasing misorientation angles, the destructive interference of overlapping d-wave order parameters across the grain boundary, and an extreme bending of the conduction bands near the grain boundary exacerbated by the low carrier density of YBCO. From the band bending perspective, grain boundary critical current enhancement results from the local injection of carriers that are naturally depleted due to the microstructure of the oxygen deficient grain boundary. The width of this depletion layer, combined with the short superconducting coherence lengths of the HTS materials, creates Josephson junctions at these grain boundaries which significantly reduce the magnitude of the critical current density. Whatever the true nature of the reduced supercurrent flow at the boundary, replacing Y with Ca at the interface adds carriers to this otherwise insulating depletion layer, and thus allows for the supercurrent to flow more freely through the interface.

It is believed that a similar doping at the surface of YBCO may occur using Hg metal. This belief has its basis in the tabulated effective ionic radii of the atoms in oxides and fluorides. Using the oxidation states of the respective ions as a guide, the ionic radii for Y⁺³, Ca⁺², and Hg⁺² in an 8 coordinate site are shown below:
Y⁺³ I_{R}=1.02 Å
Ca⁺² I_{R}=1.12 Å
Hg⁺² I_{R}=1.14 Å

From an atomic radii perspective, Hg should selectively dope the Y site in YBCO and provide additional carriers to the grain boundaries, in the same manner as Ca. Because of the high vapor pressure and toxicity of mercury metal, the entire oxygenation/doping reaction is preferably contained within a stainless steel sheath which is compatible with the mercury vapor and O₂ gas at the temperatures of the HgO decomposition. Other chemically compatible sheath materials include Nb, Ta, and Mo.

In addition to doping the grain boundaries with Hg, the interstitial regions of the filament will contain excess Hg metal from the HgO decomposition, which will be in intimate contact with the YBCO. In general, the HTS materials are powerful oxidants and readily oxidize most metals. This reaction results in the formation of insulating oxides on the HTS surface that is extremely detrimental to inter-grain supercurrent flow.

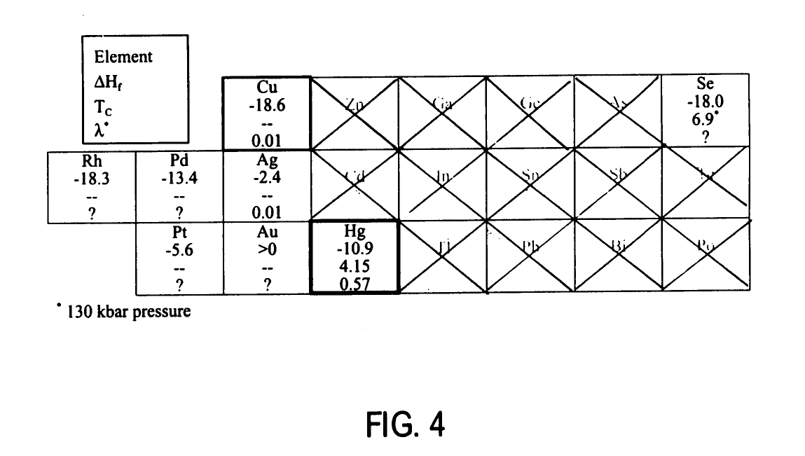

There are surprisingly few metals that are noble (i.e., non-reactive) with respect to the HTS materials. From values of the heats of formation of stable solid oxides, ΔH_{f} in kcal/(g atom), it is possible to determine which metals are thermodynamically noble with respect to oxidation by the copper oxide HTS materials. These metals are shown in FIG. 4, along with the superconducting critical temperature, T_{C}, and the electron-electron coupling constant λ*, in their respective positions on the periodic table. The seven elements that form weaker metal-oxygen bonds than the copper-oxygen bond are Rh, Pd, Ag, Pt, Au, Se, and Hg. Thermodynamically, these elements should not be oxidized by contact with the HTS materials. The more negative the ΔH_{f}, the more strongly the element binds to oxygen. From this table, it is easy to see why silver and gold are typically used to make low resistance contacts to HTS materials. Similar to Ag and Au, the excess Hg that remains in the interstitial regions of the filament after the HgO decomposition, will also not be oxidized by the YBCO.

In addition, mercury is unique in this list of seven elements that do not react with HTS materials because it is the only metal that is a superconductor at ambient pressure. It is well-known that when a superconductor is placed in clean contact with a metal, the Cooper pair amplitudes in the superconductor do not vanish abruptly at the interface, but extend a finite distance into the metal. This is known as the superconducting proximity effect. The proximity induced superconducting gap in the metal is proportional to the local Cooper pair amplitude and the magnitude of the electron-electron interaction, λ*, in the metal adjacent to the superconductor. Of silver, gold, and mercury, the latter is the only metal with a significant λ* and is thus the only metal which is susceptible to a significant superconducting proximity effect. There is a dramatic increase in the current carrying capacity of composite PIT wire with the addition of high λ* metals to the superconducting filament.

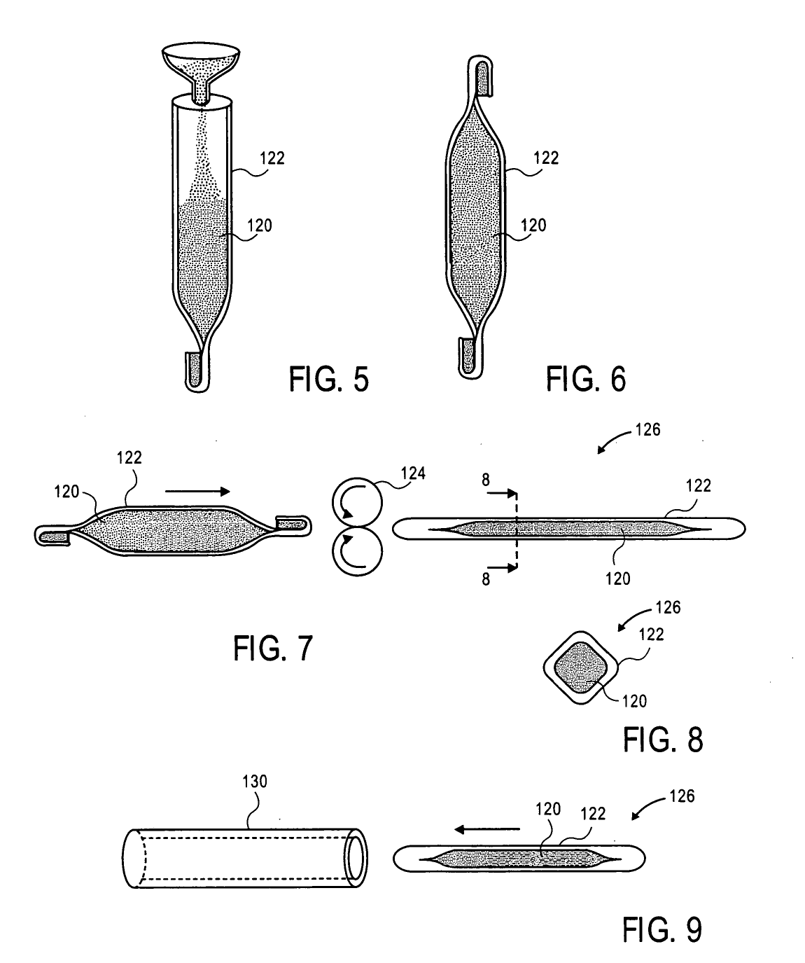

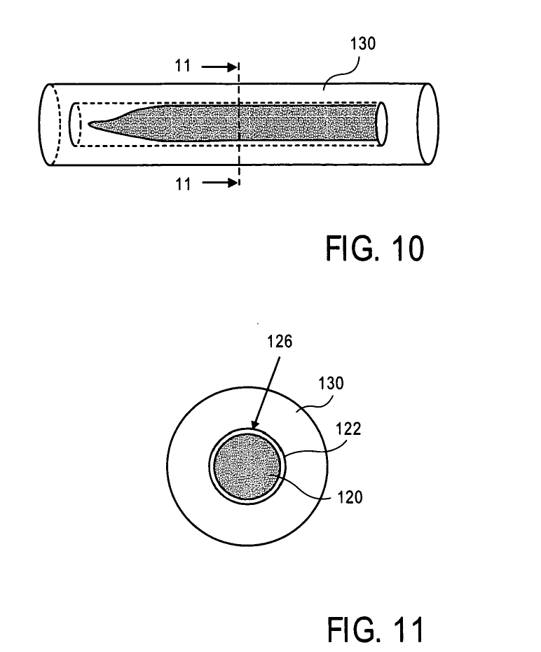

FIGS. 5 to 10 illustrate the manufacture of a mercury-based HTS wire having a stainless steel and copper shell. The stainless steel provides the benefits hereinbefore described with reference to FIGS. 1 and 2. The copper is more conductive and has a higher heat capacity than stainless steel to transfer and absorb heat from hot spots or heat spikes along the length of the wire.

As illustrated in FIGS. 5 and 6, a stainless steel billet 122 is filled with a powder mixture 120 as hereinbefore described, and the billet is sealed to provide an enclosed container for heat treatment of the powder mixture 120. As illustrated in FIG. 7, the billet 122 containing the powder mixture 120 is rolled by rollers 124 into a narrow rod 126. FIG. 8 illustrates the cross-sectional area of the rod 126. The rod 126 is longer and has a smaller cross-sectional area than the billet 122.

As illustrated in FIGS. 9 to 11, the rod 126 is subsequently inserted into a copper sleeve 130. The combination of the copper sleeve 130 and the rod 126 is then rolled into an elongate wire and heat-treated.

The foregoing thus describes the manufacture of low cost composite YBCO-based superconducting wire. The YBCO-based wire should have high magnetic field applications at 4.2K. The YBCO-based wire may also have sufficient current carrying properties in low magnetic fields at temperatures in excess of 77K for use in other superconductor applications.

While certain exemplary embodiments have been described and shown in the accompanying drawings, it is to be understood that such embodiments are merely illustrative and not restrictive of the current invention, and that this invention is not restricted to the specific constructions and arrangements shown and described since modifications may occur to those ordinarily skilled in the art.

1. A method of making an oxide superconductor composite, comprising:
preparing a combination of oxide superconductor particles and a mercury-containing metal oxide material; and
heating the combination and subsequently allowing the combination to cool.

2. The method of claim 1, wherein the oxide superconductor is YBa₂Cu₃O₇₋ₓ.

3. The method of claim 1, wherein the mercury-containing metal oxide is HgO.

4. The method of claim 1, wherein the mercury-containing oxide material consists of a mercury oxide material and a metal oxide material.

5. The method of claim 1, wherein the mercury-containing oxide material consists of a mercury oxide material, a metal oxide material, and a metal.

6. The method of claim 1, further comprising:
loading the combination in a closed billet;
forming the closed billet into a wire; and
heating the combination in the wire.

7. The method of claim 6, wherein the billet is made of at least one of stainless steel, Nb, Mo, and Ta.

8. The method of claim 6, wherein the material is heated after forming the wire.

9. The method of claim 1, wherein the mercury-containing metal oxide material thermally decomposes into at least Hg and O, both the O and Hg being provided to the particles.

10. The method of claim 6, wherein the O oxygenates the particles.

11. The method of claim 6, wherein the Hg surface dopes the particles.

12. The method of claim 6, wherein the Hg is in contact with the particles.

13. A method of making oxide superconductor wire, comprising:
preparing a combination of YBa₂Cu₃O₇₋ₓ oxide superconductor particles and HgO, where x is between 0 and 1;
forming the combination into an elongate form;
heating the combination so that the HgO decomposes into Hg and O, the O from the HgO being provided to the particles, the Hg from the HgO being provided to the surface of the particles, and the Hg from the HgO being noble with respect to oxidation by the oxide superconductor particles;
allowing the combination to cool in a manner such that at least a portion of the Hg from the decomposed HgO remains in the metallic state.
